(19) United States
(12) Patent Application Publication
(10) Pub. No.: US 2017/0175655 A1
(43) Pub. Date: Jun. 22, 2017

(54) METHOD FOR OPERATING AN ENGINE

(71) Applicant: Caterpillar Inc., Peoria, IL (US)

(72) Inventors: Bret RempelEwert, Peoria, IL (US); Adam Dye, Peoria, IL (US)

(73) Assignee: Caterpillar Inc., Peoria, IL (US)

(21) Appl. No.: 14/970,646

(22) Filed: Dec. 16, 2015

(51) Int. Cl. F02D 41/02; F02B 37/00; F01N 9/00; F01N 3/20

(52) U.S. Cl. CPC F02D 41/0235; F01N 3/2066; F02B 37/00; F01N 9/00; F01N 2900/1402; F01N 2900/0416; F01N 2900/1804; F01N 2900/08

(57) ABSTRACT

A method for operating an engine includes selectively introducing air in an exhaust conduit upstream of a selective catalytic reduction system based on an exhaust gas temperature and a nitrous oxide conversion efficiency of the selective catalytic reduction system and changing at least one engine operating map for engine operation when the nitrous oxide conversion efficiency after introducing air is above a threshold nitrous oxide conversion efficiency.

### TECHNICAL FIELD

The present disclosure relates to the field of an engine. In particular, the present disclosure relates to a system and method of operating an engine efficiently by operating a reduction system for exhaust gas treatment at optimum efficiency level.

### BACKGROUND

Engines, including diesel engines, gasoline engines, gaseous fuel-powered engines, and other engines known in the art exhaust a complex mixture of air pollutants. These air pollutants may be composed of gaseous compounds such as, for example, the oxides of nitrogen (NOx).

One way to reduce NOx content in the exhaust gas discharge to atmosphere, is to utilize a NOx reduction system mounted in the exhaust conduit of the engines. A NOx reduction system includes a substrate coated or otherwise impregnated with a catalyst. As exhaust comes into contact with the catalyst-coated substrate, the NOx may be converted into harmless compounds that are allowed to pass to the environment.

Although the NOx reduction system may be effective for removing regulated exhaust constituents, their use may be limited. In particular, NOx reduction system are most effective when the temperature of the exhaust gas flowing through the substrate is maintained within a predetermined range. And, in addition to losing NOx-removal effectiveness as the temperature of the exhaust exceeds this predetermined range, the catalyst and/or the substrate may degrade when the temperature significantly exceeds this range.

Alternative way to reduce NOx content in the exhaust gas is to change engine operating calibration or engine operating parameters. However, the change in engine calibration or engine operating parameter to reduce NOx may further result in an increase in exhaust temperature. The increase in exhaust temperature reduces the conversion efficiency of reduction system and also further reduces life of exhaust components. Alternatively, a change in engine calibration or engine operating parameters to reduce engine out exhaust gas temperature may result in higher NOx content in the exhaust gas and may also reduce overall engine operating efficiency.

U.S. Pat. No. 6,276,139 discloses an engine having a NOx reduction system in an exhaust conduit for treating exhaust gases. The patent further describes a turbocharger for providing compressed air to engine cylinders and a bypass passage for bypassing the air from location downstream of compressor of the turbocharger to the exhaust conduit upstream of the NOx reduction system so that the NOx reduction is operated within an optimum temperature range for higher efficiency.

### SUMMARY OF THE INVENTION

According to an aspect, a method for operating an engine is disclosed. The method includes selectively introducing air in an exhaust conduit upstream of a selective catalytic reduction system based on an exhaust gas temperature and a nitrous oxide conversion efficiency of the selective catalytic reduction system and changing at least one engine operating map for engine operation when the nitrous oxide conversion efficiency after introducing air is above a threshold nitrous oxide conversion efficiency.

According to another aspect, an engine is disclosed. The engine includes an air source, a selective catalytic reduction system, an exhaust conduit, a conduit, and a controller. The selective catalytic reduction system is configured to reduce nitrous oxide present in an exhaust gas. Further, the conduit is configured for introducing air from the air source in the exhaust conduit upstream of the selective catalytic reduction system. Furthermore, the controller is configured for selectively introducing air in an exhaust conduit upstream of the selective catalytic reduction system based on an exhaust gas temperature and the nitrous oxide conversion efficiency of the selective catalytic reduction system and changing at least one engine operating map for engine operation when the nitrous oxide conversion efficiency after introducing air is above a threshold nitrous oxide conversion efficiency.

According to yet another aspect, a method for operating an engine is disclosed. The method discloses selectively introducing air in an exhaust conduit upstream of a selective catalytic reduction system based on an exhaust gas temperature and a nitrous oxide conversion efficiency of the selective catalytic reduction system; and changing at least one engine operating parameter for engine operation when the nitrous oxide conversion efficiency after introducing air is above a threshold nitrous oxide conversion efficiency.

### BRIEF DESCRIPTION OF THE DRAWINGS

FIG. 1 illustrates an engine in accordance with an embodiment.

FIG. 2 illustrates a method for initiating introduction of air in an exhaust conduit and operating the engine in accordance with an embodiment.

FIG. 3 illustrates a method for operating an engine in accordance with an embodiment.

FIG. 4 illustrates a method for operating an engine in accordance with an alternative embodiment.

### DETAILED DESCRIPTION

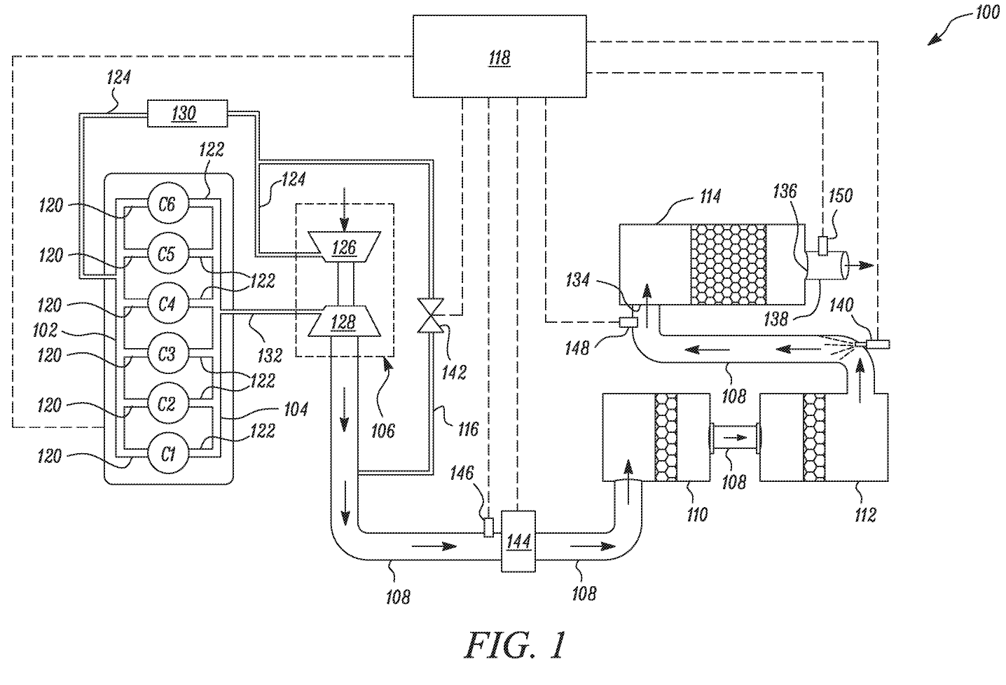

Referring to FIG. 1, there is shown an embodiment of an engine 100. The engine 100 may be a gasoline engine, a gaseous engine, a diesel engine or a dual fuel engine. The gaseous engine may use natural gas, propane gas, methane gas or any other gaseous fuel suitable for use in the gaseous engine. The engine may be a single cylinder or a multi cylinder engine. Further, the engine 100 may be a two stroke engine, a four stroke engine, or a six stroke engine. Also, the engine 100 may be a spark ignited engine, a compression ignition engine, a distributed ignition engine or a homogeneous charge compression ignition engine.

As shown in FIG. 1, the engine 100 may include an intake manifold 102, an exhaust manifold 104, an air source 106, an exhaust conduit 108, a diesel oxidation catalyst 110, a diesel particulate filter 112, a selective catalytic reduction system (SCR) 114, a conduit 116, and a controller 118. The intake manifold 102 and the exhaust manifold 104 are each fluidly coupled with a plurality of combustion cylinders C1 through C6, as indicated schematically by lines 120 and 122, respectively. In the embodiment shown, a single intake manifold 102 and exhaust manifold 104 are fluidly coupled with combustion cylinders C1 through C6. However, it is also possible to configure the intake manifold 102 and/or the exhaust manifold 104 as a split or multiple-piece manifold, each associated with a different group of combustion cylinders.

The air source 106 may be configured to provide air to the combustion cylinders C1 to C6 via an intake conduit 124. In the present embodiment, the air source 106 is a turbocharger having a compressor 126 and a turbine 128. Although, the air source 106 is contemplated as the turbocharger, other means of providing air such as intake conduit, a supercharger, a throttle valve, an air reservoir known to one skilled in art would also apply. The compressor 126 is driven by the turbine 128 to compress the air and deliver the compressed air to the combustion cylinders C1 to C6 via the intake conduit 124. A heat exchanger 130 may positioned in the intake conduit 124 between the compressor 126 and the intake manifold 102. The heat exchanger 130 is configured to cool the compressed air coming from the compressor 126 and thereby delivers a cool air to the combustion cylinders C1 to C6. The turbine 128 is driven by exhaust gas discharged from the combustion cylinders C1 to C6. The exhaust gas is delivered to the turbine 128 from the exhaust manifold 104 via the line 132.

The turbine 128 may discharge the exhaust gas to the exhaust conduit 108. The diesel oxidation catalyst 110 may be positioned in the exhaust conduit 108 downstream of the turbine 128. The diesel oxidation catalyst 110 may remove harmful constituents present in the exhaust gas. In an embodiment, the diesel oxidation catalyst 110 oxidizes the unburned hydrocarbon present in the exhaust gas. Further the diesel particulate filter 112 may be positioned in the exhaust conduit 108 downstream of the diesel oxidation catalyst 110. The diesel particulate filter 112 filters the soot or any particulate matter present in the exhaust gas. Although the diesel particulate filter 112 is contemplated, any other suitable filter such as gasoline particulate filter suitable for use with a particular engine may also be positioned in the exhaust conduit 108. Also, exhaust system without any particulate filter may also be contemplated and covered within the scope of the disclosure. Furthermore, the SCR 114 may be positioned in the exhaust conduit 108 downstream of the diesel particulate filter 112.

In an embodiment, only the SCR 114 may be positioned in the exhaust conduit downstream of the turbine 128. The SCR 114 includes an inlet 134 through which exhaust gas enters into the SCR 114. The SCR 114 also includes an outlet 136 which is connected with a line 138 to discharge the exhaust gas to the atmosphere. The SCR 114 is configured to reduce nitrous oxide (NOx) present in the exhaust gas. The SCR 114 includes a catalyst that reduces the NOx into the nitrogen in the presence of a diesel exhaust fluid. The diesel exhaust fluid may be injected into the exhaust gas before the exhaust gas enters in the SCR 114. As shown in FIG. 1, an injector 140 injects the diesel exhaust fluid in the exhaust conduit 108 upstream of the SCR 114. The diesel exhaust fluid may be a urea containing fluid, an ammonia containing fluid or any other suitable fluid which can reduce nitrous oxides present in the exhaust gas into nitrozen in the presence of suitable catalyst.

The SCR 114 generally operates at optimum NOx conversion efficiency when temperature of exhaust gas entering the SCR 114 is within a temperature range. When the temperature of the exhaust gas falls outside the temperature range, the SCR 114 operates at lesser NOx conversion efficiency than the optimum NOx conversion efficiency. Also, the reduction in the NOx conversion efficiency may be higher when the exhaust gas temperature is more than upper limit of the temperature range corresponding to optimum NOx conversion efficiency.

To maintain the temperature of the exhaust gas, the conduit 116 is configured to provide air from the air source 106 to the exhaust conduit 108. Air is mixed with the exhaust gas flow through the conduit 116 to lower the exhaust gas temperature. The conduit 116 may connect the intake conduit 124 downstream of the compressor 126 to the exhaust conduit 108 downstream of the turbine 128. In an embodiment, the conduit 116 provides air from outlet of the compressor 126 to the exhaust conduit 108. In an embodiment, the conduit 116 delivers air from the intake conduit 124 downstream of heat exchanger 130 positioned downstream of the compressor 126 to the exhaust conduit 108. In an embodiment, the conduit 116 delivers air at the inlet 134 of the SCR 114. In an embodiment, the air source 106 may be a separate air storage unit and the air is delivered from the air storage unit to the exhaust conduit 108 to lower the temperature of the exhaust gas. The amount of air introduced in the exhaust conduit 108 may be controlled by the controller 118. The amount of air introduced in the exhaust conduit 108 may depend on one or more of the following factors; temperature of air, temperature of exhaust gases in the exhaust conduit 108, pressure of exhaust gases in the exhaust conduit 108, temperature of exhaust gas at the inlet 134 of SCR 114, temperature of air at the outlet of the air source 106 etc.

The controller 118 may control actuation and the opening of a valve 142 positioned in the conduit 116 to selectively control introduction of air in the exhaust conduit 108. In an embodiment, the valve 142 is an air valve for a regeneration system 144 for the diesel particulate filter 112. In another embodiment, the valve 142 may be a solenoid actuated valve to selectively introduce and also control amount of the air entering in the exhaust conduit 108. Although a solenoid actuated valve is contemplated, other types of valves such as but not limited to a hydraulically actuated valve, a pneumatically actuated valve known to one skilled in the art would also apply. In an embodiment, the controller 118 may be an electronic control module (ECM) associated with the engine 100. In another embodiment, the valve 142 may be controlled by an independent controller 118.

The controller 118 may include a non-transient computer readable storage media (not shown) including code, engine operating maps, operating parameters for enabling monitoring and control of the engine 100. The controller 118 may be configured to receive signals from a variety of engine sensors, as further elaborated herein, in order to determine operating parameters and operating conditions, and correspondingly adjust various engine actuators to control operation of the engine 100. For example, the controller 118 may receive signals from various engine sensors including, but not limited to, engine speed, engine load, intake manifold air pressure, air reservoir pressure, exhaust pressure, ambient pressure, exhaust temperature, NOx sensors etc. Correspondingly, the controller 118 may send a signal to the valve 142 to inject air from the air source 106 into the exhaust conduit 108 based on communication from engine sensors indicating the temperature of the exhaust gas in the exhaust conduit 108 and the NOx conversion efficiency of the SCR 114. In an embodiment, an exhaust gas temperature sensor 146 may be positioned in the exhaust conduit 108. As shown in FIG. 1, the exhaust gas temperature sensor 146 is positioned downstream of the turbine 128.

The controller 118 may determine the NOx conversion efficiency based on the NOx level present in the exhaust gas in the exhaust conduit 108 at a location upstream of the SCR 114 and the NOx content present in the line 138 downstream of the SCR 114. In an embodiment, the NOx content upstream of the SCR 114 is measured by a first NOx sensor 148. The first NOx sensor 148 may be positioned in the exhaust conduit 108 at the inlet 134 of the SCR 114. Although, positioning of the first NOx sensor 148 at the inlet 134 of SCR 114 is contemplated, the first NOX sensor 148 may be positioned anywhere in the exhaust conduit 108 upstream of the SCR 114 such as but not limited to an inlet of the exhaust manifold 104, an outlet of the exhaust manifold 104 etc. Similarly, the NOx content downstream of the SCR 114 may be measured by a second NOx sensor 150 positioned downstream of the SCR 114 in the line 138.

Further, the controller 118 is configured to introduce the air from the air source 106 in the exhaust conduit 108 when the temperature of the exhaust gas is above a threshold temperature and the NOx conversion efficiency of the SCR 114 is below a threshold NOx conversion efficiency. After introducing air in the exhaust conduit 108, the controller 118 monitors the NOx conversion efficiency of the SCR 114 and is configured to change at least one engine operating map for operating the engine 100 when the NOx conversion efficiency is above a threshold NOx conversion efficiency in accordance with an embodiment.

The controller 118 changes the engine operating map to improve engine efficiency. In an embodiment, the engine operating map is a fuel rail pressure map. The fuel rail pressure map may be changed such that the injection timing of the fuel in the combustion cylinders C1 to C6 or in the intake manifold 102 is retarded or advanced as compared to the injection timing of the fuel during normal operation. In an embodiment, the engine operating map is an oxygen fuel ratio map. In another embodiment, the engine operating map is a combustion timing map. The combustion timing map may be changed such that the timing of initiation of combustion in the combustion cylinders C1 to C6 is retarded or advanced. Although, the change in fuel rail pressure map and/or the oxygen fuel ratio map are contemplated, change in any other engine operating maps suitable for increasing engine efficiency known to a person skilled in the art would also apply.

In another embodiment, the controller 118 is configured to change at least one operating parameter for operating the engine 100 when the NOx conversion efficiency of the SCR 114 after introducing the air in the exhaust conduit 108 is above the threshold NOx conversion efficiency. In the present embodiment, the operating parameter is a fuel injection timing. The fuel injection timing refers to timing of injection of fuel either in the combustion cylinders C1 to C6 or in the intake manifold 102. The controller 118 may change the fuel injection timing for the engine 100 such that engine 100 may operate at increased efficiency. In an embodiment, the fuel injection timing may be retarded as compared to fuel injection timing during normal operation to operate the engine 100 at the increased engine efficiency. In another embodiment, the fuel injection timing may be advanced as compared to fuel injection timing during normal operation to operate the engine 100 at the increased engine efficiency. Similarly, the operating parameter is a combustion timing in the combustion cylinders C1 to C6. The combustion timing may be changed to operate the engine 100 at the increased efficiency. Although fuel injection timing or combustion timing is contemplated as the operating parameter, other operating parameter of the engine 100 suitable for increasing engine efficiency as known to a person skilled in art may also apply.

Further, the controller 118 may change the engine operating map or the operating parameter for the engine 100 over a period of time to avoid any sudden change or fluctuation in the engine operation. In an exemplary embodiment, the controller 118 may use a linear map between time and change in operating parameter of the engine 100 to control the overall change in operating parameter for engine operation over a period of time thereby avoiding a step change in the operating parameter or operating map. In an example, when the operating parameter is a fuel injection timing, the controller 118 may determine a fuel injection timing advance of X degree for operating the engine at increased efficiency. This may be achieved after introducing air in the exhaust conduit 108, by dividing the change of X degree over period of time, say 100 milliseconds. The controller 118 may accordingly control the fuel injection such that fuel injection timing is advanced by X/10 degree every 10 milliseconds. This helps in smooth change in operating parameter or operating map for engine operation. In another exemplary embodiment, the controller 118 may use a linear map between the number of strokes and the change in operating parameter to bring the change in the operating parameter or operating map. Although a linear map is contemplated for bringing a change in the operating parameter or operating map, other suitable maps such as but not limited to quadratic, cubical, logarithmic know in the art would also apply.

Furthermore, the controller 118 may again change the engine operating map or operating parameter to an engine operating map or an operating parameter associated with normal operation of the engine 100 when the exhaust gas temperature falls below a second threshold temperature. The second threshold temperature may be less than or equal to the threshold temperature necessary for starting introduction of air in the exhaust conduit 108. In an embodiment, the second threshold temperature is kept less than the threshold temperature so that the controller 118 avoids oscillation of engine operation due to frequent changing of engine operating maps or operating parameter based on the exhaust gas temperature. In an embodiment, the exhaust gas temperature may be monitored in the exhaust conduit 108 at location downstream of location where the conduit 116 is connected to the exhaust conduit 108. In an embodiment, the exhaust gas temperature is monitored at the outlet of the turbine 128. In an embodiment, the exhaust gas temperature is monitored in the exhaust manifold 104.

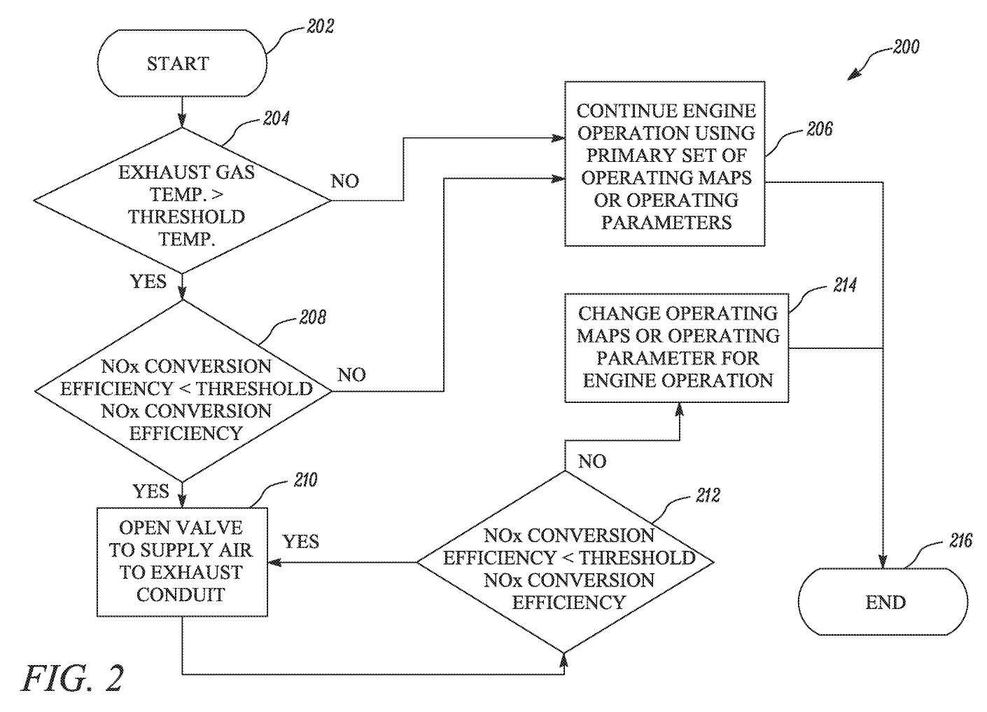

Referring to FIG. 2, a method 200 is shown. The method 200 relates to a trigger strategy for operating the engine 100 based on temperature of exhaust gas. The method 200 starts at a step 202. The method 200 further includes a step 204. At the step 204, the controller 118 detects the temperature of the exhaust gases in the exhaust conduit 108 and compares the exhaust gas temperature to the threshold temperature. The controller 118 may detect the exhaust gas temperature in the exhaust conduit 108 upstream of the SCR 114. The method 200 moves to a step 206 when the temperature of the exhaust gas is below the threshold temperature. At the step 206, the controller 118 operates the engine 100 at normal operating mode. The normal operating mode refers an operating mode in which engine is operated based on a primary set of engine operating maps. The primary set of engine operating maps refers to the standard operating maps for operating the engine 100.

When the exhaust gas temperature is above the threshold temperature, the method 200 moves to a step 208. At the step 208, the controller 118 checks the NOx conversion efficiency of the SCR 114. Further, the controller 118 compares the NOx conversion efficiency to the threshold NOx conversion efficiency. The method 200 moves to the step 206 when the NOx conversion efficiency of the SCR 114 is above the threshold NOx conversion efficiency.

At the step 206, the controller 118 may operate the engine 100 at the normal operating mode when the exhaust gas temperature is above the threshold temperature and the NOx conversion efficiency of the SCR 114 is above the threshold NOx conversion efficiency. The controller 118 may determine the NOx conversion efficiency of SCR 114 at the detected exhaust gas temperature in the exhaust conduit 108 upstream of the SCR 114. In another embodiment, the controller 118 may determine exhaust gas temperature at the inlet 134 of the SCR 114.

The method 200 moves to a step 210 when the NOx conversion efficiency of the SCR 114 at the detected exhaust gas temperature is below the threshold NOx conversion efficiency and the detected exhaust gas temperature is above the threshold temperature. At the step 210, the controller 118 may control the valve 142 to introduce air in the exhaust conduit 108. The air is introduced from the air source 106 to the exhaust conduit 108 via the conduit 116. Amount of the air supplied to the exhaust conduit 108 is controlled by the controller 118 by adjusting an opening area of the valve 142. The controller 118 may determine the amount of air to be supplied to the exhaust conduit 108 based on the exhaust gas temperature and requisite NOx conversion efficiency of the SCR 114. Further, the method 200 moves to a step 212.

At the step 212, the controller 118 may determine the NOx conversion efficiency of the SCR 114 after introducing the air in the exhaust conduit 108. Further, at the step 212, the controller 118 compares the NOx conversion efficiency of the SCR 114 after introducing the air is compared to the threshold NOx conversion efficiency of the SCR 114. Hereinafter, the NOx conversion efficiency of the SCR 114 after introducing air in the exhaust conduit 108 may be referred as new NOx conversion efficiency. When the new NOx conversion efficiency of the SCR 114 is below the threshold NOx conversion efficiency, the method 200 moves back to the step 210.

Further, the method 200 moves to a step 214 when the new NOx conversion efficiency of the SCR 114 is above the threshold NOx conversion efficiency. At the step 214, the controller 118 changes the engine operating map or operating parameter for the engine operation to operate the engine 100 at the increased efficiency than the normal operating mode.

The changed engine operating map or the operating parameter is associated with a cool down mode. The cool down mode refers to an engine operating mode in which the engine 100 is operated when the exhaust gas temperature is above the threshold temperature and the NOx conversion efficiency is below the threshold conversion efficiency.

In the cool down mode, the SCR 114 operates at optimum NOx conversion efficiency so that the engine 100 may be operated at increased efficiency level. In the cool down mode, the engine operation may result in the increased NOx content in the engine out exhaust gas flowing through the exhaust conduit 108. However, as the SCR 114 may be operating at optimum NOx conversion efficiency, the NOx content present in the exhaust gas discharged to atmosphere may be equal to or less than the NOx content present in the exhaust gas discharged to the atmosphere when the engine 100 is operated in normal operating mode.

Further, the controller 118 may include various other parameters in addition to the parameters described in the method 200 before operating the engine 100 in the cool down mode. One of the parameter may be regeneration of the diesel particulate filter 112. Although regeneration of the diesel particulate filter 112 is explained, the engine 100 with a gasoline particulate filter or any other particulate filter may also operate in a similar manner. The diesel particulate filter 112 is configured to remove/filter the particulate matter from the exhaust gas. Over a period of time, the diesel particulate filter 112 may get completely clogged with the particulate matter. For unclogging the diesel particulate filter 112, the particular matter present in the filter is burned. The removal of particulate matter from the diesel particulate filter 112 by burning the particulates is known as regeneration.

For regenerating of the diesel particulate filter 112, a temperature of the exhaust gas is raised. The temperature of the exhaust gas may be raised by controlling the engine operation such that the temperature of the engine out exhaust gas is high enough to burn the particulate matter clogging the diesel particulate filter 112. The temperature of the exhaust gas may also be increased by introducing additional air in the exhaust conduit 108 by using the air valve for the regeneration system 144 and utilizing the additional air for burning fuel injected in the exhaust conduit 108.

As high temperature of the exhaust gas is desired for regeneration, the controller 118 may not initiate the cool down mode during regeneration. The controller 118 may also check if the regeneration of the diesel particulate filter 112 is to be initiated within a predetermined time duration, then the controller 118 may suspend the initiation of method 200 to prevent engine operation in the cool down mode. Further, the controller 118 may check other similar or suitable parameters before initiating the method 200 to operate the engine 100 in the cool down mode. The method 200 ends at a step 216.

### INDUSTRIAL APPLICABILITY

The present disclosure provides for the conduit 116 configured for introducing air from the air source 106 to the exhaust conduit 108 for mixing with exhaust gas flowing through the exhaust conduit 108. The introduction of air in the exhaust conduit 108 lowers temperature of exhaust gas entering the SCR 114 so that the SCR 114 may be operated at optimum NOx conversion efficiency. Also, controller 118 facilitates introduction of air in the exhaust conduit 108 such that the engine 100 may be operated at increased efficiency by changing the engine operating map or operating parameter for engine operation when SCR 114 NOx conversion efficiency is above the threshold NOx conversion efficiency.

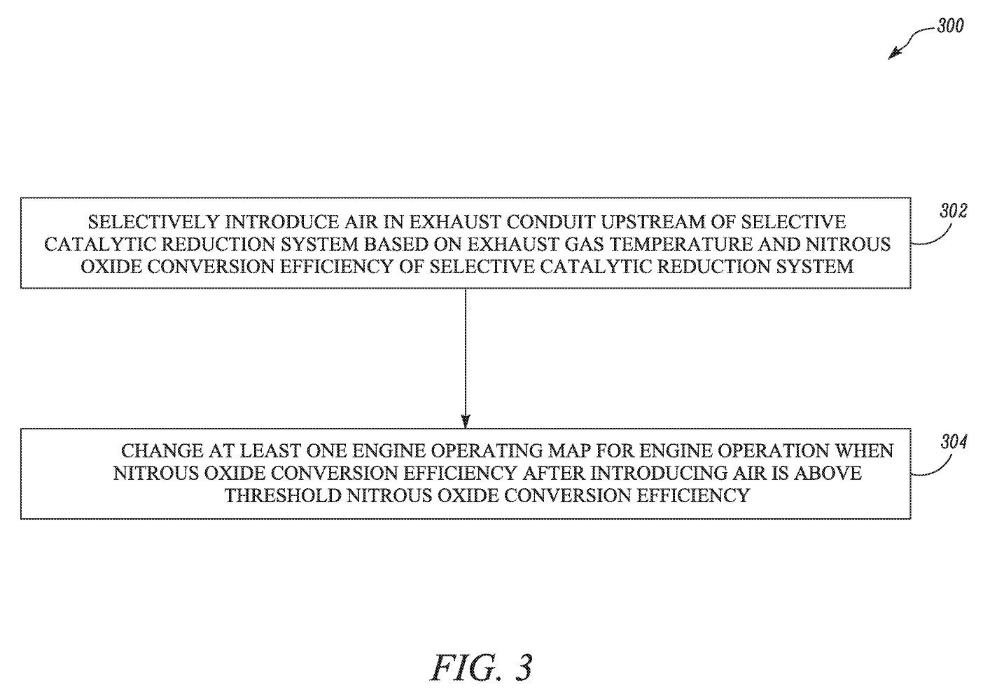

Further, the present disclosure provides for a method 300 for operating the engine 100 in accordance with an embodiment. Referring to FIG. 3, the method 300 includes a step 302 in which air is selectively introduced in the exhaust conduit 108 based on the exhaust gas temperature and the NOx conversion efficiency of the SCR 114. The controller 118 introduces air to the exhaust conduit 108 when the temperature of the exhaust gas is above the threshold temperature and the NOx conversion efficiency of the SCR 114 is below the threshold NOx conversion efficiency. The air may be introduced in the exhaust conduit 108 at the inlet 134 of the SCR 114 or at a location upstream of the SCR 114.

Amount of the air introduced in the exhaust gas may be controlled by the controller 118 by controlling the actuation and opening area of the valve 142. In an embodiment, the valve 142 is a solenoid actuated valve. In an embodiment, the valve 142 may be the air valve for regeneration system 144 of the diesel particulate filter 112. The controller 118 may control the amount of air introduced in the exhaust conduit 108 so that temperature of exhaust gas inside or entering the SCR 114 is such that the NOx conversion efficiency of the SCR 114 is above the threshold NOx conversion efficiency.

The method 300 further includes a step 304 in which the engine operating map of the engine 100 is changed for engine operation when the NOx conversion efficiency of the SCR 114 after introducing air in the exhaust conduit 108 is above the threshold NOx conversion efficiency. In an embodiment, the engine operating map is fuel rail pressure map. In an embodiment, the engine operating map is oxygen fuel ratio map.

Operating the engine 100 by changing the engine operating map may increases the engine efficiency. The engine 100 when operated by changing the engine operating map may discharge exhaust gas with increased NOx content. However, as the SCR 114 is operated at increased NOx conversion efficiency, the total NOx content in the exhaust gas discharged to atmosphere may remain at the same or lower level as that of NOx content in the exhaust gas when engine 100 is operated without changing the engine operating map.

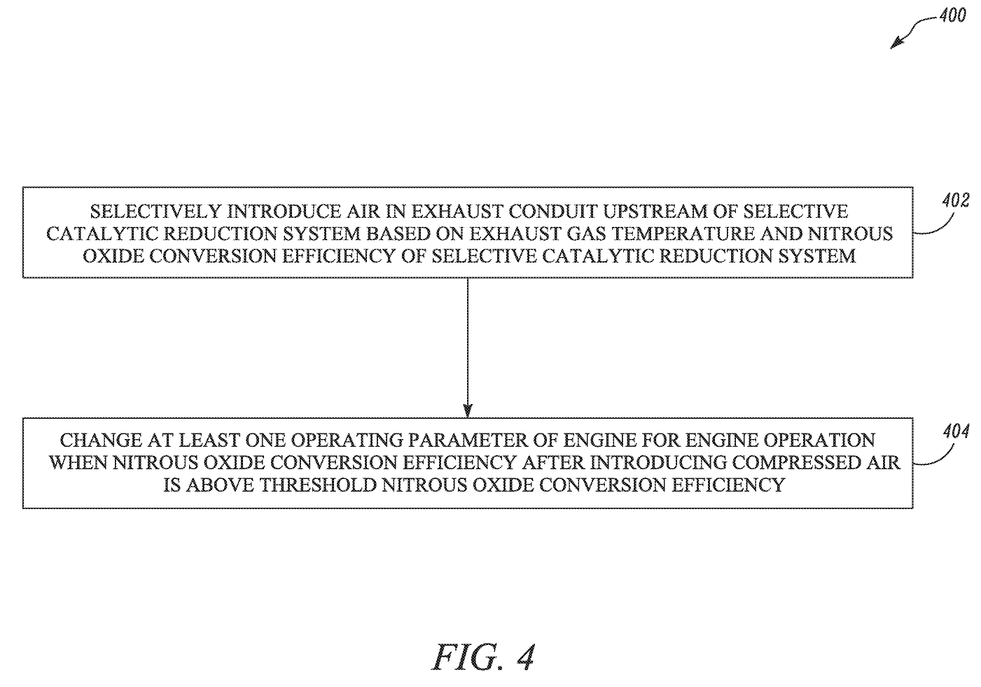

Furthermore, the present disclosure provides for a method 400 for operating the engine 100 in accordance with an alternative embodiment of the disclosure. Referring to FIG. 4, the method 400 includes a step 402 in which air is selectively introduced in the exhaust conduit 108 based on the exhaust gas temperature and the NOx conversion efficiency of the SCR 114. The controller 118 introduces air to the exhaust conduit 108 when the temperature of the exhaust gas is above the threshold temperature and the NOx conversion efficiency of the SCR 114 is below the threshold NOx conversion efficiency. The air may be introduced in the exhaust conduit 108 at the inlet 134 of the SCR 114 or at a location upstream of the SCR 114.

Amount of the air introduced in the exhaust gas may be controlled by the controller 118 by controlling the actuation and opening area of the valve 142. In an embodiment, the valve 142 is a solenoid actuated valve. In an embodiment, the valve 142 may be the air valve for regeneration system 144 of the diesel particulate filter 112. The controller 118 may control the amount of air introduced in the exhaust conduit 108 so that temperature of exhaust gas inside or entering the SCR 114 is such that the NOx conversion efficiency is above the threshold NOx conversion efficiency.

The method 400 further includes a step 404 in which the operating parameter of the engine 100 is changed for engine operation when the NOx conversion efficiency of the SCR 114 after introducing air in the exhaust conduit 108 is above the threshold NOx conversion efficiency. In an embodiment, the operating parameter for the engine 100 is fuel injection timing. In another embodiment, the operating parameter for the engine 100 is a fuel injection pressure. In an embodiment, the operating parameter for the engine 100 is intake valve opening time. Although, fuel injection timing is contemplated as the operating parameter, other suitable operating parameter known in the art may also be changed for operating the engine 100 at increased engine efficiency.

Operating the engine 100 by changing the operating parameter may increases the engine efficiency. The engine 100 when operated by changing the operating parameter may discharge exhaust gas with increased NOx content. However, as the SCR 114 is operated at increased NOx conversion efficiency, the total NOx content in the exhaust gas discharged to atmosphere may remain at the same or lower level as that of NOx content in the exhaust gas when engine 100 is operated without changing the operating parameter.

What is claimed is:

1. A method for operating an engine, comprising:
selectively introducing air in an exhaust conduit upstream of a selective catalytic reduction system based on an exhaust gas temperature and a nitrous oxide conversion efficiency of the selective catalytic reduction system; and
changing at least one engine operating map for engine operation when the nitrous oxide conversion efficiency after introducing air is above a threshold nitrous oxide conversion efficiency.

2. The method of claim 1, wherein the air is introduced when the exhaust gas temperature is above a threshold temperature and the nitrous oxide conversion efficiency is below the threshold nitrous oxide conversion efficiency.

3. The method of claim 1, wherein the nitrous oxide conversion efficiency is determined by comparing nitrous oxide content in exhaust gas at an inlet and an outlet of the selective catalytic reduction system.

4. The method of claim 1, wherein the air is introduced at an inlet of the selective catalytic reduction system.

5. The method of claim 1, wherein the engine operating map is a rail pressure map.

6. The method of claim 1, wherein the engine operating map is an oxygen fuel ratio map.

7. An engine comprising:
an air source;
a selective catalytic reduction system configured to reduce nitrous oxide present in an exhaust gas;
a conduit configured for introducing air from the air source in an exhaust conduit upstream of the selective catalytic reduction system; and
a controller configured for:
selectively introducing air in the exhaust conduit upstream of the selective catalytic reduction system based on an exhaust gas temperature and a nitrous oxide conversion efficiency of the selective catalytic reduction system; and
changing at least one engine operating map for engine operation when the nitrous oxide conversion efficiency after introducing air is above a threshold nitrous oxide conversion efficiency.

8. The engine of claim 7, wherein the air source is a turbocharger.

9. The engine of claim 7, wherein the air is introduced when the exhaust gas temperature is above a threshold temperature and the nitrous oxide conversion efficiency is below the threshold nitrous oxide conversion efficiency.

10. The engine of claim 7, wherein the nitrous oxide conversion efficiency is determined by comparing nitrous oxide content in exhaust gas at an inlet and an outlet of the selective catalytic reduction system.

11. The engine of claim 7, wherein the air is introduced at an inlet of the selective catalytic reduction system.

12. The engine of claim 7, wherein the engine operating map is a fuel rail pressure map.

13. The engine of claim 7, wherein the engine operating map is an oxygen fuel ratio map.

14. The engine of claim 7, wherein the engine comprises a valve for controlling amount of air injected upstream of the selective catalytic reduction system.

15. The engine of claim 14, wherein the valve is air valve for a regeneration system.

16. A method for operating an engine, comprising:
selectively introducing air in an exhaust conduit upstream of a selective catalytic reduction system based on an exhaust gas temperature and a nitrous oxide conversion efficiency of the selective catalytic reduction system; and
changing at least one operating parameter of the engine for engine operation when the nitrous oxide conversion efficiency after introducing compressed air is above a threshold nitrous oxide conversion efficiency.

17. The method of claim 16, wherein air is introduced when the exhaust gas temperature is above a threshold temperature and the nitrous oxide conversion efficiency is below the threshold nitrous oxide conversion efficiency.

18. The method of claim 16, wherein the air is introduced at an inlet of the selective catalytic reduction system.

19. The method of claim 16, wherein the operating parameter is a fuel injection pressure.

20. The method of claim 16, wherein the operating parameter is a fuel injection timing.
